(19) United States
(12) Patent Application Publication
(10) Pub. No.: US 2011/0027512 A1
(43) Pub. Date: Feb. 3, 2011

(54) CONDUCTIVE POLYAMIDE COMPOSITE COMPOSITION AND FUEL TRANSPORT TUBE USING THE SAME

(75) Inventors: Choon Soo Lee, Seoul (KR); Min Hee Lee, Hwaseong (KR); Joung Sook Hong, Suwon (KR); Jin Young Huh, Gunpo (KR); Doo Han Ha, Anyang (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); CHEIL INDUSTRIES INC.

(21) Appl. No.: 12/621,161

(22) Filed: Nov. 18, 2009

(30) Foreign Application Priority Data
Jul. 30, 2009 (KR) 10-2009-0070149

(51) Int. Cl. H01B 1/24; B32B 1/08

(52) U.S. Cl. 428/36.9; 252/511

(57) ABSTRACT

A conductive polyamide composite composition including (A) 100 parts by weight of a base resin containing (A-1) 50 to 99% by weight of a polyamide resin and (A-2) 1 to 50% by weight of a polyolefin resin, (B) 0.1 to 20 parts by weight of an olefin-copolymer with respect to 100 parts by weight of the base resin, (C) 1 to 15 parts by weight of a carbon black, (D) 0.01 to 5 parts by weight of carbon nanotubes, (E) 0.01 to 10 parts by weight of a plasticizer, and (F) 0.01 to 2 parts by weight of a resin stabilize, and a fuel transport tube prepared using the same are provided.

### CROSS-REFERENCE TO RELATED APPLICATION

This application claims under 35 U.S.C. §119(a) the benefit of Korean Patent Application No. 10-2009-0070149 filed Jul. 30, 2009, the entire contents of which are incorporated herein by reference.

### BACKGROUND

(a) Technical Field

The present disclosure relates, generally, to a conductive polyamide composite composition. More particularly, it relates to a conductive polyamide composite composition and a fuel transport tube prepared using the same.

(b) Background

Typically, nonconductive polyamide resin compositions that are generally used in conventional vehicle fuel systems have poor safety since static electricity may be generated by the friction that is created when fuel circulates through a fuel transport tube. Accordingly, in order to prevent this static electricity, conductive materials are preferably used to manufacture the fuel transport tubes. Generally, a high content of conductive filler is added to impart suitable conductivity to the polyamide resin, thus leading to a poor appearance and a high manufacturing cost.

In general, polyamide resin has been applied to vehicle internal or external parts for a variety of uses since it has excellent mechanical strength, abrasion resistance, heat resistance, chemical resistance, electrical insulating properties, arc resistance, etc. When the polyamide resin is molded into fuel tubes or hoses by a co-extrusion process, for example, it requires high melt elasticity for molding and rubber phase mixing. Moreover, since there are problems such as compatibility between polyamide and rubber, flexibility, viscosity, and workability, the applications of polyamide resin are suitably limited. Further, since the content of carbon black for imparting conductivity is generally more than 20% by weight, there are technical limitations in suitably uniformly dispersing the rubber phase and the conductive filler in the tube.

Korean Patent Publication No. 10-2004-0074615, incorporated by reference in its entirety herein, is directed to a polyamide/polyolefin composition comprising 0.1 to 10% by weight of single-walled carbon nanotubes with respect to 90 to 99.9% by weight of a resin containing (A) 60 to 70% by weight of a polyamide and (B) 5 to 15% by weight of a polyolefin containing LLDPE and ethylene/alkyl(meth)acrylate/maleic anhydride copolymer. However, since the content of carbon nanotubes added to the polyamide/polyolefin composition to impart conductivity is considerably high, the carbon nanotubes are not uniformly dispersed in the composition and the compatibility with the resin is suitably reduced. Accordingly, the molded articles of the above invention have a suitably poor appearance and a suitably reduced conductivity, and thus there are limitations in using the composition as a material for manufacturing the fuel transport tube.

Korean Patent Publication No. 10-2007-0073965, incorporated by reference in its entirety herein, discloses a conductive thermoplastic resin composition comprising 20 to 80% by weight of a poly(arylene ether), 80 to 20% by weight of a polyamide, a compatibilizer, a conductivity-imparting agent for conductive carbon black or carbon fiber, and a clay filler. However, this conductive thermoplastic resin cannot suitably achieve the properties and conductivity required for the formation of the fuel transport tube, and thus is not suitable to be used as a material for manufacturing the fuel transport tube.

The above information, disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention provides a conductive polyamide composite composition having excellent conductivity and compatibility. In preferred embodiments, the present invention provides a fuel transport tube suitably prepared using the conductive polyamide composite composition.

In one preferred embodiment, the present invention provides a conductive polyamide composite composition preferably comprising: (A) 100 parts by weight of a base resin containing (A-1) 50 to 99% by weight of a polyamide resin and (A-2) 1 to 50% by weight of a polyolefin resin; (B) 0.1 to 20 parts by weight of an olefin-copolymer with respect to 100 parts by weight of the base resin; (C) 1 to 15 parts by weight of a carbon black; (D) 0.01 to 5 parts by weight of carbon nanotubes; (E) 0.01 to 10 parts by weight of a plasticizer; and (F) 0.01 to 2 parts by weight of a resin stabilizer.

In another preferred embodiment, the present invention provides a fuel transport tube that is suitably prepared using a conductive polyamide composite composition.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is an electron microscope image of a sample prepared using a conductive polyimide composite composition according to Example 3;

FIG. 2 is a highly magnified image FIG. 1; and

FIG. 3 is an electron microscope image of a mixture of carbon nanotubes and carbon black in the sample prepared using the conductive polyimide composite composition according to Example 3.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention includes a conductive polyamide composite composition comprising (A) 100 parts by weight of a base resin containing (A-1) a polyamide resin and (A-2) a polyolefin resin; (B) 0.1 to 20 parts by weight of an olefin-copolymer with respect to 100 parts by weight of the base resin; (C) 1 to 15 parts by weight of a carbon black; (D) 0.01 to 5 part by weight of carbon nanotubes; (E) 0.01 to 10 parts by weight of a plasticizer; and (F) 0.01 to 2 parts by weight of a resin stabilizer.

In one embodiment, the base resin contains (A-1) 50 to 99% by weight of a polyamide resin.

In another embodiment, the base resin contains (A-2) 1 to 50% by weight of a polyolefin resin.

In another aspect, the invention also features a fuel transport tube prepared using the conductive polyamide composite composition of claim 11.

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

A conductive polyamide composite composition according to certain preferred embodiments of the present invention will be described in more detail below.

(A) Base Resin

According to preferred embodiments of the present invention, a base resin of the present invention comprises a polyamide resin and a polyolefin resin.

(A-1) Polyamide Resin

According to other preferred embodiments of the present invention, a polyamide resin in accordance with an exemplary embodiment of the present invention preferably has an amino group in its main chain and is suitably prepared by polymerizing an amino acid, a lactam or diamine, and a dicarboxylic acid.

Examples of the amino acid include, but are not meant to be limited only to, 6-aminocaproic acid, 11-aminoundecanoic acid, 12-aminododecanoic acid, and para-aminomethylbenzoic acid. Examples of the lactam include, but are not meant to be limited only to, ε-caprolactam and ω-laurolactam. Examples of the diamine include, but are not meant to be limited only to, aliphatic, alicyclic or aromatic diamines such as tetramethylenediamine, hexamethylenediamine, 2-methylpentamethylenediamine, nonamethylenediamine, undecamethylenediamine, dodecamethylenediamine, 2,2,4-trimethylhexamethylenediamine, 5-methylnonamethylenediamine, metaxylenediamine, paraxylenediamine, 1-3bis(aminomethyl)cyclohexane, 1,4-bis(aminomethyl)cyclohexane, 1-amino-3-aminomethyl-3,5,5-trimethylcyclohexane, bis(4-aminocyclohexyl)methane, bis(3-methyl-4-aminocyclohexyl)methane, 2,2-bis(4-aminocyclohexyl)propane, bis(aminopropyl)piperazine, and aminoethylpiperazine. Examples of the dicarboxylic acid include, but are not meant to be limited only to, aliphatic, alicyclic or aromatic dicarboxylic acid such as adipic acid, suberic acid, azelaic acid, sebacic acid, dodecane-2-acid, terephthalic acid, isophthalic acid, 2-chloroterephthalic acid, 2-methylterephthalic acid, 5-methylisophthalic acid, 5-sodiumsulfoisophthalic acid, 2,6-naphthalenedicarboxylic acid, hexahydroterephthalic acid, and hexahydroisophthalic acid. According to further preferred embodiments of the invention, a polyamide homopolymer or copolymer derived from these raw materials may be used solely or as a mixture thereof.

Preferably, examples of the polyamide resin include, but are not meant to be limited only to, polycaprolactam(polyamide 6), poly(11-aminoundecanoic acid)(polyamide 11), polylauryllactam(polyamide 12), poly-4,6-tetramethylenediamine adipic acid (polyamide 4,6), polyhexamethylene adipic acid (polyamide 6,6), polyhexaethylene azelamide (polyamide 6,9), polyhexaethylene sebacamide(polyamide 6,10), polyhexaethylene dodecanediamide (polyamide 6,12), polyamide 6/6,10 copolymer, polyamide 6/6,6 copolymer, polyamide 6/12 copolymer, and combinations thereof. In particular preferred embodiments, the polyamide resin may be selected from the group consisting of, but not limited to, polyamide 4,6, poly(11-aminoundecanoic acid)(polyamide 11), and combinations thereof. More particularly, the polyamide resin may be poly(11-aminoundecanoic acid)(polyamide 11). In further preferred embodiments, the poly(11-aminoundecanoic acid)(polyamide 11) provides excellent gasoline resistance and low wettability.

Preferably, the polyamide resin should have a melting point of more than 185° and a relative viscosity of more than 2 (measured at 25° C. after adding 1% by weight of a polyamide resin to m-cresol). In this case, preferably, the conductive polyamide composite composition has excellent mechanical properties and heat resistance.

According to other further preferred embodiments, the polyamide resin may include at least one type of polyamide with a glass transition temperature of more than 50° without limitations.

In other further embodiments, the polyamide resin may be suitably contained in an amount of 50 to 99% by weight with respect to the total amount of the base resin containing polyamide resin and polyolefin resin. Preferably, the polyamide resin may be suitably contained in an amount of 55 to 99% by weight. In certain exemplary embodiments, the conductive polyamide composite composition has excellent conductivity and mechanical properties such as gasoline resistance, tensile strength, and impact strength. In other further embodiments, when the amount of the polyamide resin contained in the base resin is less than 50% by weight, the conductivity and other properties of the conductive polyamide composition and the polyamide resin prepared using the same may suitably deteriorate.

(A-2) Polyolefin Resin

The polyolefin resin in accordance with another exemplary embodiment of the present invention has an effect of selectively dispersing a conductive filler in the polyamide resin of the conductive polyamide composite composition. Accordingly, the polyolefin resin serves to suitably reduce the content of the conductive filler required to impart conductivity to the conductive polyamide composite composition. Preferably, due to the use of polyolefin resin, the content of the conductive filler used in the conductive polyamide composite composition is suitably reduced, thereby reducing the cost and improving properties such as impact strength.

In further preferred embodiments, the mixture of polyolefin resin and polyamide resin suitably improves the wettability of the polyamide resin and suitably reduces the content of the polyamide resin, which results in a suitable reduction in the cost.

Preferably, since the polyolefin resin has a suitably low compatibility with the polyamide resin, it is possible to suitably stabilize the conductive polyamide composite composition under the presence of an olefin copolymer by an ordinary preparation method.

Preferably, the polyolefin resin may be selected from the group consisting of, but not limited only to, high density polyethylene (HDPE) with a density range of 0.94 to 0.965, linear low density polyethylene (LLDPE) with a density range of 0.91 to 0.94, polypropylene, ethylene-vinylalcohol copolymer, ethylene-propylene copolymer, and combinations thereof. In further preferred embodiments, the polyolefin resin may be suitably contained in an amount of 1 to 50% by weight with respect to the total amount of the base resin containing polyamide resin and polyolefin resin. Preferably, the polyolefin resin may be suitably contained in an amount of 15 to 45% by weight. Preferably, the conductive polyamide composite composition has excellent conductivity and gasoline resistance.

(B) Olefin Copolymer

The conductive polyamide composite composition in accordance with another exemplary embodiment of the present invention preferably comprises an olefin copolymer to suitably improve the compatibility between polyamide resin and polyolefin resin of the base resin.

According to other preferred embodiments of the present invention, the olefin copolymer may be selected from the group consisting of, but not limited only to, olefin-acrylate copolymer, olefin-maleic anhydride modified copolymer, and combinations thereof. In particular preferred embodiments, the olefin-maleic anhydride modified copolymer may be used. Preferably, it is possible to effectively improve the compatibility between polyolefin resin and polyamide resin.

According to certain preferred embodiments of the present invention, the olefin-acrylate copolymer may be selected from the group consisting of, but not limited to, ethylene methyl-acrylate copolymer, ethylene ethyl-acrylate copolymer, ethylene butyl-acrylate copolymer, ethylene vinyl-acrylate copolymer, and combinations thereof.

According to certain preferred embodiments of the present invention, the olefin-maleic anhydride modified copolymer may be selected from the group consisting of, but not limited only to, ethylene butene-maleic anhydride modified copolymer, ethylene octene-maleic anhydride modified copolymer, ethylene propylene-maleic anhydride modified copolymer, and combinations thereof.

In further preferred embodiments, the olefin-maleic anhydride modified copolymer may comprise 0.1 to 10 parts by weight of maleic anhydride branches with respect to 100 parts by weight of its main chain. In particular preferred embodiments, the maleic anhydride branches may be suitably contained in an amount of 0.5 to 5 parts by weight. Preferably, the compatibility between polyamide and polyolefin and their basic properties are suitably improved.

In other further embodiments, the olefin copolymer may be suitably contained in an amount of 0.1 to 20 parts by weight with respect to 100 parts by weight of the base resin containing polyamide resin and polyolefin resin. Preferably, the olefin copolymer may be suitably contained in an amount of 5 to 15 parts by weight. In certain exemplary embodiments, the compatibility between polyamide resin and polyolefin resin is excellent and, since the olefin copolymer does not form its phase, it is possible to suitably obtain a substantially uniform dispersion and a good appearance.

(C) Carbon Black

The carbon black in accordance with another further exemplary embodiment of the present invention may preferably be selected from the group consisting of, but not limited only to, ketjen black, acetylene black, furnace black, channel black, and combinations thereof. In particular preferred embodiments, the ketjen black having a higher conductivity than the others may be used.

Preferably, carbon black particles having a diameter of 10 to 30 nm are aggregated with an average diameter of 10 μm to provide the conductivity.

Preferably, the carbon black may be contained in an amount of 1 to 15 parts by weigh with respect to 100 parts by weight of the base resin containing polyamide resin and polyolefin resin. In further preferred embodiments, the carbon black may be suitably contained in an amount of 5 to 10 parts weight. Preferably, the carbon black provides excellent conductivity. According to further preferred embodiments, when the content of the filler for imparting conductivity is suitably lower, it is more economical and easier to improve the properties of the filler.

(D) Carbon Nanotubes

The carbon nanotubes in accordance with an exemplary embodiment of the present invention may preferably be selected from the group consisting of, but not only limited to, single-walled carbon nanotubes, double-walled carbon nanotubes, multi-walled carbon nanotubes, and combinations thereof.

Preferably, when the aspect ratio (i.e., ratio of length to diameter) of the carbon nanotubes is suitably larger, it is more difficult to disperse the carbon nanotubes, and thus it is desirable to use the multi-walled carbon nanotubes having a diameter of 1 to 30 nm and a length of less than 50 μm.

Preferably, the carbon nanotubes may be contained in an amount of 0.01 to 5 parts by weight with respect to 100 parts by weight of the base resin containing polyamide resin and polyolefin resin. In particular preferred embodiments, the carbon nanotubes may be suitably contained in an amount of 0.1 to 1.0 parts by weight. Preferably, it is easy to achieve electrical percolation for imparting conductivity to the conductive polyamide composite composition, and it is thus possible to suitably uniformly disperse the carbon nanotubes in the conductive polyamide composite composition within the process time, thus maintaining the properties of the base resin such as mechanical strength (e.g., tensile strength) and thermal stability.

Preferably, since the conductive polyamide composite composition in accordance with an embodiment of the present invention is suitably prepared using the mixture of carbon black and carbon nanotubes, the amount of conductive filler can be considerably reduced, thereby improving the dispersion properties of additives such as a compatibilizer.

(E) Plasticizer

A preferred plasticizer in accordance with an exemplary embodiment of the present invention can not only suitably improve the fluidity and moldability of the conductive polyamide composite composition but also suitably enhance the dispersion properties of carbon nanotubes and carbon black.

Preferably, the plasticizer may be selected from the group consisting of, but not limited only to, ethylene bis-stearamide, pentaerythritol, polycaprolactone, high density polyethylene (HDPE), caster oil, ortho-toluene sulfonamide, para-toluene sulfonamide, and combinations thereof.

Preferably, the plasticizer may be contained in an amount of 0.01 to 10 parts by weight with respect to 100 parts by weight of the base resin containing polyamide resin and polyolefin resin. In particular preferred embodiments, the plasticizer may be contained in an amount of 1 to 6 parts by weight. Preferably, the fluidity and moldability are suitably excellent, and the dispersion properties of carbon nanotubes and carbon black are improved.

(F) Resin Stabilizer

A resin stabilizer in accordance with an exemplary embodiment of the present invention serves to suitably stabilize the polyamide resin and polyolefin resin contained in the conductive polyamide composite composition when molded articles are suitably produced using the conductive polyamide composite composition by, for example, extrusion or injection, thus suitably preventing these resins from being decomposed (e.g., thermal decomposition) or from reacting with each other. According to certain preferred embodiments, with the addition of such a resin stabilizer, the polyamide resin or polyolefin resin in the conductive polyamide composite composition can suitably exhibit its characteristics, and the thermal stability and moldability of the conductive polyamide composite composition can be considerably improved.

Preferably, any resin stabilizer, which is well known in the art, may be used without particular limitations. For example, according to certain preferred embodiments, the resin stabilizer may be selected from the group consisting of, but not limited only to, phosphoric acid, triphenylphosphite, trimethylphosphite, triisodecylphosphite, tri-(2,4,-di-t-butylphenyl)phosphite, 3,5-di-t-butyl-hydroxybenzylphosphonic acid, tetrakis propionate methane, and combinations thereof.

In further preferred embodiments, the resin stabilizer may be contained in an amount of 0.01 to 2 parts by weight with respect to 100 parts by weight of the base resin containing polyamide resin and polyolefin resin. In particular preferred embodiments, the resin stabilizer may be suitably contained in an amount of 0.5 to 2 parts by weight. Preferably, the thermal stability and moldability of the conductive polyamide composite composition are suitably excellent.

According to certain preferred exemplary embodiments, the conductive polyamide composite composition can be suitably prepared by mixing the above-described components, and the molded articles can be suitably produced by melt-extruding the thus prepared conductive polyamide composite composition.

Preferably, the conductive polyamide composite composition has a surface resistance of less than 10E+7 Ω/cm² when immersed in 20% ethanol and fuel at 60° C., thus exhibiting excellent conductivity. Further, the conductive polyamide composite composition has excellent properties such as moldability, chemical resistance, and impact strength. Preferably, since the conductive polyamide composite composition has excellent properties such as moldability as well as conductivity, it can be used to suitably prepare a high volatile fuel transport tube, and further it can be used in various applications such as a vehicle fuel system.

According to another exemplary embodiment of the present invention, a fuel transport tube prepared using the above-described conductive polyamide composite composition is provided.

Preferably, the fuel transport tube has a structure that contains the base resin containing polyamide resin and polyolefin resin, the olefin copolymer suitably dispersed in the base resin, the carbon black, the carbon nanotubes, the plasticizer, and the resin stabilizer. Preferably, a molded article is suitably produced using the conductive polyamide composite composition comprising carbon black and carbon nanotubes in accordance with an exemplary embodiment of the present invention such that the carbon black particles having a diameter of several microns and uniformly dispersed in the molded article are effectively connected to each other by the carbon nanotubes, thus imparting electrical conductivity even with a small amount of the conductive filler. In further preferred embodiments, this molded plastic article has excellent properties such as moldability, thermal stability, and chemical resistance.

Exemplary embodiments of the present invention will be described in more detail with reference to the following Examples. However, these Examples are only for purposes of illustration and are not intended to limit the present invention.

Detailed specifications of (A) a base resin containing (A-1) a polyamide resin and (A-2) a polyolefin resin, (B) an olefin copolymer, (C) a carbon black, (D) carbon nanotubes, (E) a plasticizer, and (F) a resin stabilizer, which will be used in the following Examples and Comparative Examples, are as follows:

(A) Base Resin

(A-1) Polyamide Resin

(A-1-1) Polyamide 11

According to certain preferred embodiments, Polyamide 11 (Arkema, BESNO P40TL) having a viscosity of 1,000 [Pa·s] (100[1/s]) at 220° was used.

(A-1-2) Polyamide 11

According to other preferred embodiments, Polyamide 11 (Arkema, BESNO TL) having a viscosity of more than 10,000 [Pa·s] (100[1/s]) at 220° was used.

(A-2) Polyolefin Resin

According to certain preferred embodiments, linear low density polyethylene (Samsung Total 4222F) having an average molecular weight (Mw) of more than 1,000 g/mol was used.

(B) Olefin Copolymer

According to certain preferred embodiments, ethylene-butene-maleic anhydride copolymer (DuPont, Fusabond MN493D) was used.

(C) Carbon Black

According to other preferred embodiments, ketjen black (Akzo Nobel, EC600JD) was used.

(D) Carbon Nanotubes

according to certain preferred embodiments, multi-walled carbon nanotubes (Nanocy, NC7000) having a diameter of 1 to 30 nm was used.

(E) Plasticizer

According to certain preferred embodiments, ortho-toluene sulfonamide) was used.

(F) Resin Stabilizer

According to other preferred embodiments, IRGANOX B 1171 (Ciba Geigy), which is a mixture of IRGANOX 1098 (hindered phenolic antioxidant) and IRGAFOS 168 (organo-phosphite) in a ratio of 1:1, was used.

### Examples 1 to 3 & Comparative Examples 1 to 5

In certain exemplary embodiments of the present invention, conductive polyamide composite compositions in accordance with Examples 1 to 3 and Comparative Examples 1 to 5 were prepared by mixing the above-described constituent components in the mixing ratios shown in the following Table 1:

TABLE 1

| | | Example | | | Comparative Example | | | | |
|---|---|---|---|---|---|---|---|---|---|
| Components | | 1 | 2 | 3 | 1 | 2 | 3 | 4 | 5 |
| (A) | (A-1-1) Polyamide 11 | 78 | 52 | — | 78 | 78 | 78 | 78 | 100 |
| Base Resin | (A-1-2) Polyamide 11 | — | — | 76 | — | — | — | — | — |
| (% by weight) | (A-2) Polyolefin | 22 | 48 | 24 | 22 | 22 | 22 | 22 | — |

| | | | | | | | | |
|---|---|---|---|---|---|---|---|---|
| (B) Olefin Copolymer (parts by weight) | 16 | 11.5 | 18 | 16 | 16 | 16 | — | 16 |
| (C) Carbon Black (parts by weight) | 6 | 5 | 10 | — | 6 | 6 | 6 | — |
| (D) Carbon Nanotubes (parts by weight) | 0.25 | 0.1 | 0.01 | 0.25 | — | 0.25 | 0.25 | 0.01 |
| (E) Plasticizer (parts by weight) | 4 | 0.1 | 6 | 4 | 4 | — | 4 | — |
| (F) Resin Stabilizer (parts by weight) | 0.4 | 0.4 | 0.4 | 0.4 | 0.4 | 0.4 | 0.4 | 0.4 |

[Preparation of Samples for Property Measurement]

Preferably, the conductive polyamide composite compositions according to Examples 1 to 3 and Comparative Examples 1 to 5 were suitably melt-extruded in a biaxial melt extruder heated to 250° and suitably formed into pellets.

In further preferred embodiments, the thus formed pellets were dried at 100 for four hours, and ASTM samples were suitably prepared using the dried pellets in a screw-type injector heated to 250° to evaluate the conductivity and mechanical properties such as flexural strength, tensile strength, and impact strength.

### Test Example 1

### Measurement of Mechanical Properties

In further exemplary embodiments of the present invention, tensile strengths of the samples of Examples 1 to 3 and Comparative Examples 1 to 5 prepared in the same manner as above were suitably measured in accordance with ASTM D638, U.S. standard test method for tensile strength of plastics. In further exemplary embodiments, flexural strengths of the samples of Examples 1 to 3 and Comparative Examples 1 to 5 prepared in the same manner as above were suitably measured in accordance with ASTM D790, U.S Standard Test Method for flexural strength of plastics. In further exemplary embodiments, impact strengths of the samples of Examples 1 to 3 and Comparative Examples 1 to 5 prepared in the same manner as above were suitably measured in accordance with ASTM D256, U.S Standard Test Method for impact strength of plastics. The thus measured mechanical strengths are shown in the following Table 2.

### Test Example 2

### Measurement of Conductivity

In the exemplary embodiments of the present invention, surface resistances of the samples of Examples 1 to 3 and Comparative Examples 1 to 5 prepared in the same manner as above were suitably measured using a surface resistance meter (Wolfgang, SRM-110) after being suitably immersed in gasoline for 200 hours and suitably dried at 80° for four hours, and the results are shown in the following Table 2.

### Test Example 3

### Measurement of Dispersion Properties

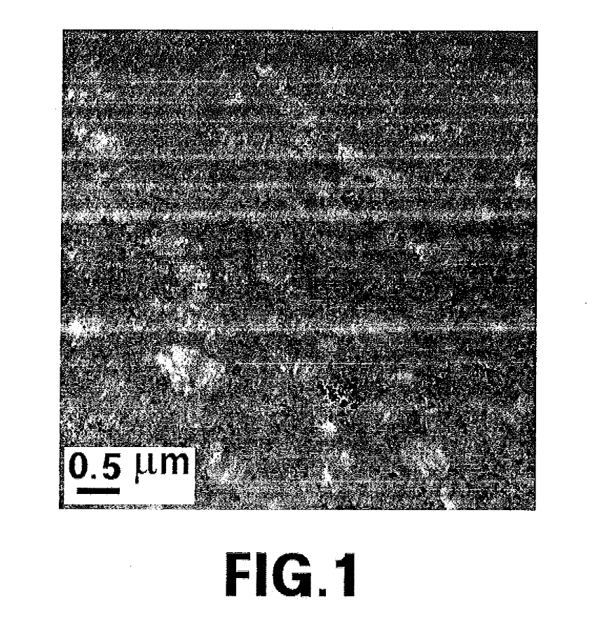

In further exemplary embodiments of the present invention, dispersion properties of carbon black and carbon nanotubes in the sample of Example 3 were suitably measured using a transmission electron microscope (TEM) and the results are shown in FIGS. 1 to 3.

TABLE 2

| | | | | | | Measurement |
|---|---|---|---|---|---|---|
| | | Measurement of Mechanical Strengths | | | | of Conductivity |
| | | Tensile Strength | Flexural Strength | Impact Strength | | Surface |
| | | [kgf/cm², 50 | [kgf/cm², 2.8 | [kgf · | Elongation | Resistance |
| Classification | | mm/min] | mm/min] | cm/cm] | [%] | [Ω/cm²] |
| Example | 1 | 324 | 285 | 60.2 | 80 | E+6 |
| | 2 | 240 | 234 | 65.7 | 62 | E+6 |
| | 3 | 322 | 139 | 67.7 | 190 | E+5 |
| Comparative | 1 | 270 | 230 | 90 | 80 | E+12 |
| Example | 2 | 330 | 260 | 70 | 70 | E+9 |
| | 3 | 300 | 290 | 55 | 20 | E+7 |
| | 4 | 380 | 300 | 15 | 40 | E+7 |
| | 5 | 340 | 255 | 70 | 55 | E+12 |

It can be seen from Table 2 that the conductive polyamide composite compositions prepared by melt-mixing the base resin containing polyamide resin and polyolefin resin with the polyolefin copolymer, the carbon black, the carbon nanotubes, the plasticizer, and the resin stabilizer in the mixing ratios according to an exemplary embodiment of the present invention had excellent conductivity and mechanical properties.

The samples of Examples 1 to 3 had suitably excellent impact strength compared to that of Comparative Example 4 which contained no olefin copolymer. The base resin containing polyamide resin and polyolefin resin, which contained the olefin copolymer, exhibited suitably improved compatibility, thus improving the impact strength.

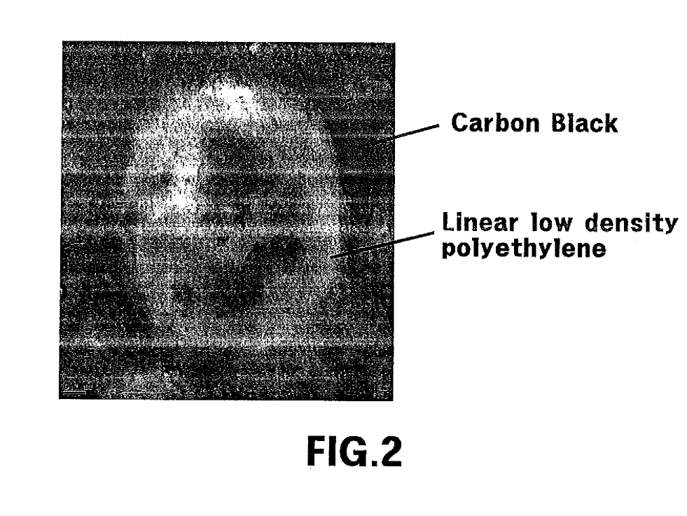

Since the added carbon black and carbon nanotubes have excellent affinity for polyamide resin compared to polyolefin resin, most carbon black and carbon nanotubes are suitably dispersed in the polyamide resin, and thus it is possible to suitably impart conductivity even with a small amount of carbon black and carbon nanotubes. FIG. 1 shows the morphology of Example 3, from which it can be seen that the added carbon black and carbon nanotubes were suitably dispersed in the polyamide resin forming a continuous phase. As shown in the highly magnified image of FIG. 2, most carbon black is suitably dispersed in the polyamide resin and, particularly, concentrated on the interface between the resins. Moreover, the carbon black is hardly observed on the polyolefin resin.

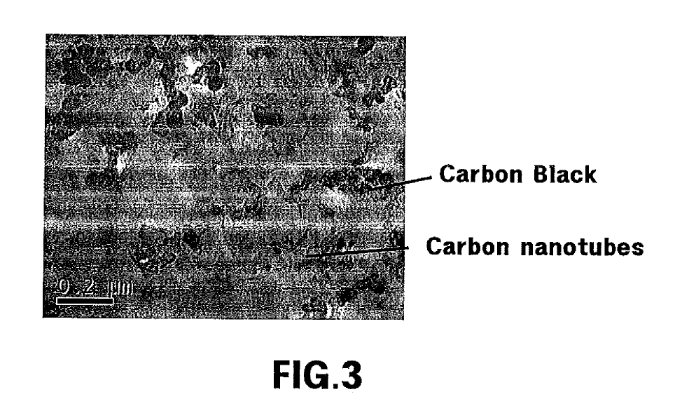

According to certain preferred embodiment and as shown in FIG. 3, the carbon nanotubes serve as an electrical bridge between carbon black particles, and thus it is possible to suitably reduce the amount of conductive filler for imparting conductivity. For example, in Comparative Example 3, in which no plasticizer was used, the conductivity was not achieved although the material properties were improved by the compatibility between polyamide resin and polyolefin resin. Accordingly, it can be understood that the plasticizer increases fluidity and, at the same time, improves the dispersion properties of carbon black and carbon nanotubes.

As described in the embodiments and aspects herein, the conductive polyamide composite composition in accordance with preferred exemplary embodiments of the present invention is suitably prepared using a mixture of carbon black and carbon nanotubes. Preferably, since the carbon black and carbon nanotubes have suitably higher affinity for the polyamide resin than the polyolefin resin, they are mainly concentrated around the polyamide resin, and the carbon nanotubes electrically connect the carbon black particles, thus achieving the conductivity even with a suitably low content of conductive filler. As a result, the samples of Examples 1 to 3 have excellent conductivity and mechanical properties such as tensile strength and impact strength due to the efficient dispersion of carbon black and carbon nanotubes and the compatibility between polyamide resin and polyolefin resin.

According to other further preferred embodiments of the invention, the amount of conductive filler used to prepare a fuel transport tube may be considerably reduced is to improve the appearance of the fuel transport tube and reduce the cost. Further, the conductive polyamide composite composition exhibits excellent electrical conductivity, and thus it is possible to suitably prevent the static electricity and improve material properties such as gasoline resistance, tensile strength, impact strength, and moldability.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A conductive polyamide composite composition comprising:
(A) 100 parts by weight of a base resin containing (A-1) 50 to 99% by weight of a polyamide resin and (A-2) 1 to 50% by weight of a polyolefin resin;
(B) 0.1 to 20 parts by weight of an olefin-copolymer with respect to 100 parts by weight of the base resin;
(C) 1 to 15 parts by weight of a carbon black;
(D) 0.01 to 5 part by weight of carbon nanotubes;
(E) 0.01 to 10 parts by weight of a plasticizer; and
(F) 0.01 to 2 parts by weight of a resin stabilize.

2. The conductive polyamide composite composition of claim 1, wherein the polyamide resin is selected from the group consisting of: polycaprolactam(polyamide 6), poly(11-aminoundecanoic acid)(polyamide 11), polylauryllactam(polyamide 12), poly4,6-tetramethylenediamine adipic acid (polyamide 4,6), polyhexamethylene adipic acid (polyamide 6,6), polyhexaethylene azelamide (polyamide 6,9), polyhexaethylene sebacamide(polyamide 6,10), polyhexaethylene dodecanediamide (polyamide 6,12), polyamide 6/6,10 copolymer, polyamide 6/6,6 copolymer, polyamide 6/12 copolymer, and combinations thereof.

3. The conductive polyamide composite composition of claim 1, wherein the polyolefin resin is selected from the group consisting of: high density polyethylene, linear low density polyethylene, polypropylene, ethylene-vinylalcohol copolymer, ethylene-propylene copolymer, and combinations thereof.

4. The conductive polyamide composite composition of claim 1, wherein the olefin copolymer is selected from the group consisting of: olefin-acrylate copolymer, olefin-maleic anhydride modified copolymer, and combinations thereof.

5. The conductive polyamide composite composition of claim 4, wherein the olefin-acrylate copolymer is selected from the group consisting of: ethylene methyl-acrylate copolymer, ethylene ethyl-acrylate copolymer, ethylene butyl-acrylate copolymer, ethylene vinyl-acrylate copolymer, and combinations thereof.

6. The conductive polyamide composite composition of claim 4, wherein the olefin-maleic anhydride modified copolymer is selected from the group consisting of: ethylene butene-maleic anhydride modified copolymer, ethylene octene-maleic anhydride modified copolymer, ethylene propylene-maleic anhydride modified copolymer, and combinations thereof.

7. The conductive polyamide composite composition of claim 1, wherein the carbon black is selected from the group consisting of: ketjen black, acetylene black, furnace black, channel black, and combinations thereof.

8. The conductive polyamide composite composition of claim 1, wherein the carbon nanotubes are selected from the group consisting of: single-walled carbon nanotubes, double-walled carbon nanotubes, multi-walled carbon nanotubes, and combinations thereof.

9. The conductive polyamide composite composition of claim 1, wherein the plasticizer is selected from the group consisting of: ethylene bis-stearamide, pentaerythritol, polycaprolactone, high density polyethylene, caster oil, ortho-toluene sulfonamide, para-toluene sulfonamide, and combinations thereof.

10. A fuel transport tube prepared using the conductive polyamide composite composition of claim 1.

11. A conductive polyamide composite composition comprising:
(A) 100 parts by weight of a base resin containing (A-1) a polyamide resin and (A-2) a polyolefin resin;
(B) 0.1 to 20 parts by weight of an olefin-copolymer with respect to 100 parts by weight of the base resin;
(C) 1 to 15 parts by weight of a carbon black;
(D) 0.01 to 5 part by weight of carbon nanotubes;
(E) 0.01 to 10 parts by weight of a plasticizer; and
(F) 0.01 to 2 parts by weight of a resin stabilizer.

12. The conductive polyamide composite composition of claim 11, wherein the base resin contains (A-1) 50 to 99% by weight of a polyamide resin.

13. The conductive polyamide composite composition of claim 11, wherein the base resin contains (A-2) 1 to 50% by weight of a polyolefin resin.

14. A fuel transport tube prepared using the conductive polyamide composite composition of claim 11.
